(19) United States
(12) Patent Application Publication
(10) Pub. No.: US 2016/0179063 A1
(43) Pub. Date: Jun. 23, 2016

(54) PIPELINE GENERATION FOR DATA STREAM ACTUATED CONTROL

(71) Applicant: Microsoft Technology Licensing, LLC, Redmond, WA (US)

(72) Inventors: Alexandre De Baynast De Septfontaines, Aachen (DE); Markus Cozowicz, Vienna (AT); Philipp Kranen, Bergheim (DE); Thomas Santen, Aachen (DE)

(21) Appl. No.: 14/573,866

(22) Filed: Dec. 17, 2014

(51) Int. Cl. G05B 15/02

(52) U.S. Cl. CPC G05B 15/02

(57) ABSTRACT

A control system is described which receives a live data steam of time stamped sensor data observed from a system. The control system accesses a store of time-stamped sensor data from the live data stream. A plurality of pipeline configurations is generated for analyzing the live data stream. Each pipeline configuration comprises a plurality of components for analyzing data, an order of the components, and values of one or more parameters of each component. The pipeline configurations are evaluated by applying the pipeline configurations to data from the store. A ground truth selector is configured to receive user input comprising ground truth data being labeled data items from the store of time-stamped sensor data. The pipeline configurations are re-evaluated using the ground truth data to select one of the pipeline configurations. Control is achieved using output of the selected one of the pipeline configurations executing on the live data stream.

### BACKGROUND

Live data streams of sensor data empirically observed from computing networks, manufacturing systems, telecommunications networks, and other apparatus can be analyzed to facilitate management and control of those systems. Typically the analysis involves processing the sensor data using a pipeline of components such as statistical computation components, classification components, and others. The task of designing and configuring the pipeline, for the particular application domain, requires specialist knowledge of a team of people such as data scientists, machine learning engineers and others. This is time consuming, complex and costly as several iterations are generally needed between the application domain experts and the data scientists. During this back and forth process, output from live stream sensor data analysis can be inappropriate, wrong, or inaccurate and this in turn detriments control of telecommunications networks, manufacturing systems and the like.

The embodiments described below are not limited to implementations which solve any or all of the disadvantages of known pipeline generation processes for control using data stream analysis.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

A control system is described which has a communications interface receiving a live data steam of time stamped sensor data observed from a system to be controlled. The control system has an uploader configured to access a store of time-stamped sensor data from the live data stream; and a configuration manager configured to generate a plurality of pipeline configurations for analyzing the live data stream (or data retained from the live data stream). Each pipeline configuration comprises a plurality of components for analyzing data, an order of the components, and, if applicable, values of one or more parameters of each component. The configuration manager is configured to evaluate the pipeline configurations by applying the pipeline configurations to data from the store. A ground truth selector is configured to receive user input comprising ground truth data being labeled data items, or labeled groups of data items within a selected time interval, from the store of time-stamped sensor data. The configuration manager is configured to re-evaluate the pipeline configurations using the ground truth data and to select one of the pipeline configurations on the basis of the re-evaluation, such that the system to be controlled may be controlled using output of the selected one of the pipeline configurations executing on the live data stream.

In some examples the selected pipeline configuration is automatically implemented at nodes of a pipeline processing the live data stream in order to actuate control of a system from which the live data stream is observed. For example to control provisioning of online mailboxes, to control a telecommunications network, to control a wireless local area network, to control nodes of a cloud service.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of a pipeline generator deployed together with analytics computation nodes in an email server control system;

FIG. 2 is a flow diagram of a method at the pipeline generator of FIG. 1;

FIG. 3 is a flow diagram of another method at a pipeline generator;

FIG. 4 is a schematic diagram of a graphical user interface showing entry of ground truth data by a user;

FIG. 5 is a schematic diagram of a pipeline generator in more detail, and during a pipeline generation phase;

FIG. 6 is a schematic diagram of the pipeline generator of FIG. 5 after operationalization;

FIG. 7 is a flow diagram of another method at a pipeline generator;

FIG. 8 illustrates an exemplary computing-based device in which embodiments of a pipeline generator may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

Although the present examples are described and illustrated herein as being implemented in an email server control system, the system described is provided as an example and not a limitation. As those skilled in the art will appreciate, the present examples are suitable for application in a variety of different types of control systems such as medical device control systems, robotics systems, telecommunications network control systems, computer network security systems.

The inventors have found that it is possible to automate design and operationalization of a live data stream analytics pipeline to control email servers (or other systems). By automating the design it is possible to achieve accurate, high performance control without the need for specialist machine learning engineers and data scientists. The possibility of human error is removed so that the resulting analytics pipeline is well suited for the application domain, is found more quickly than otherwise, and gives more accurate and efficient control. In addition, the design can be implemented automatically by sending commands to the email servers or other systems. In some examples, automated design and operationalization occurs dynamically, on-the-fly, so that performance is continually improved despite changes in the equipment being controlled. A data analytics pipeline is one or more data processing components connected together. In some examples, the components are connected in series so that output of a component earlier in the pipeline is used as input of an immediately subsequent component of the pipeline. A data analytics pipeline takes as input a time series of sensor data, which is a time stamped stream of numerical or categorical values that may be historical or live. A data analytics pipeline processes the time series of sensor data by extracting features from the data and for example, identifying patterns in the data or intervals of the data which are unexpected.

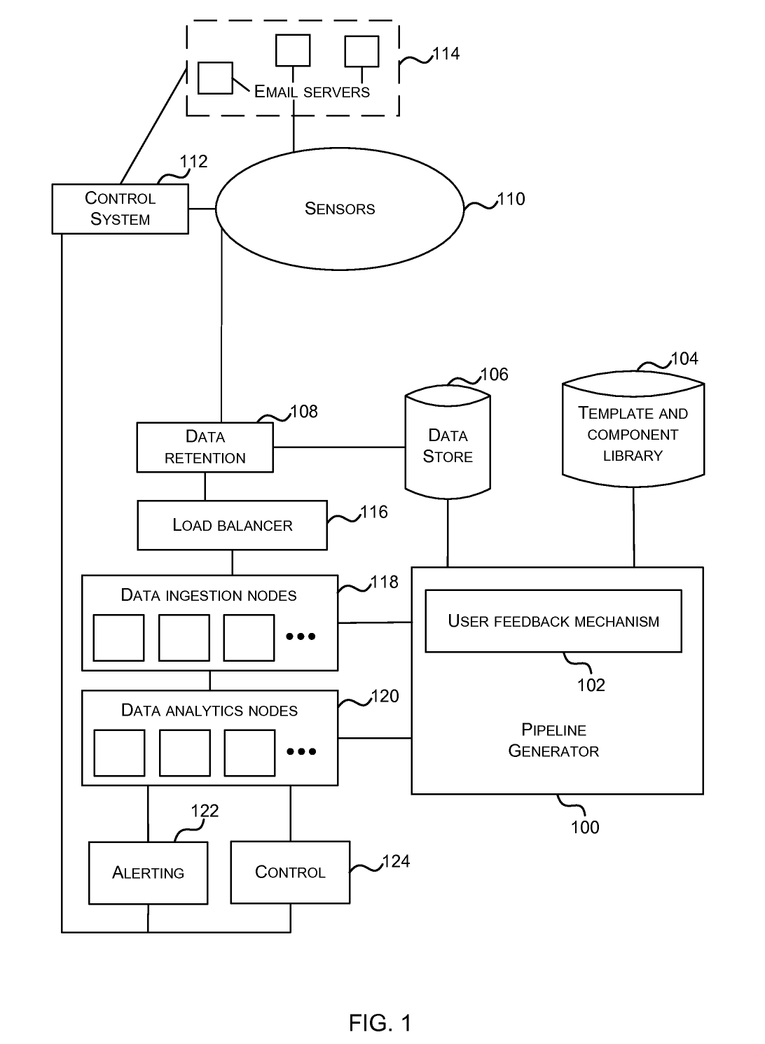

FIG. 1 is a schematic diagram of a pipeline generator 100 deployed together with data analytics nodes 120 in an email server 114 control system 112. A plurality of email servers 114 are controlled by control system 112 which is able to intelligently balance load between the email servers 114 (taking into account multiple factors such as available capacity, capacity of communications links, characteristics of email accounts), set configuration parameters of the email servers for mailbox provisioning for example, and, in some examples, configure how the email servers are interconnected. Control system 112 receives data from sensors 110 which may be at the email servers 114 or may be remote from the email servers 114. The sensors monitor available capacity of the email servers, throughput of the email servers, error metrics, and other performance data. In some examples the sensors monitor traffic levels, or other capacity indicators of communications links of the email servers.

The control system 112 comprises rules, criteria or thresholds to enable it to control the email servers 114 on the basis of the raw sensor data. In addition, or alternatively, the control system 112 receives instructions from alerting component 122 and/or control component 124 of a data analytics pipeline implemented in one or more data analytics nodes 120. The data analytics nodes are computational nodes which carry out computations specified by the components of the pipeline. The computations may be distributed over a plurality of computational nodes for web scale deployments involving huge amounts of real time data. In some examples the data analytics nodes 120 are nodes of a data center.

Data from sensors 110 is input to the data analytics pipeline at the data analytics nodes 120. For example, the data from sensors 110 is input to the pipeline via a load balancer 116 and data ingestion nodes 118. Load balancer 116 allocates the sensor data between a plurality of data ingestion nodes 118 by taking into account available capacity of the data ingestion nodes and other factors. The data ingestion nodes 118 pre-process the sensor data, for example, to convert the sensor data into compatible units of measurement, to convert the sensor data into compatible numbers of decimal places, to remove noise, to re-format the data, to align time stamp values of the sensor data.

In some examples, a data retention component 108, which is computer implemented, copies some of the sensor data 110 streamed from sensors 110 to a data store 106. The data to be copied may be selected at random, or in other ways, over a specified time interval. The data store is accessible to the pipeline generator 100.

The output of the pipeline comprises an output stream of higher level numerical or categorical values computed from the input data stream. The output stream is used by an alerting component 122 to trigger an alert such as a visual or audible alert to an operator, or an error message sent to control system 112. The output stream is used by a control component 124 to generate instructions to send to control system 112 to control the email servers.

The pipeline generator has access to a library 104 of templates and components. A template comprises a plurality of processing steps, a list of possible components for each processing step, the connections between the processing steps (the data flow), the list of parameters per component and the value ranges or possible values per parameter.

A component is a data processing component for use in a data analytics pipeline which computes one or more features of time stamped data. A component may be parameterized, in that it takes as input values of one or more parameters. For example, a window size, whether to take samples at random or in a specified manner, which type of average to compute, or other parameters. A non-exhaustive list of examples of components is: a moving average computation component, a component which computes a derivative of numerical values in a specified window of a time series, a component which detects seasonal features of a time series such as an expected value of a variable per time of day, day of month features, a component which maintains a distribution of the time series values, a component which performs statistical tests of current readings against a distribution of the time series that has been maintained over time, a component comprising a signal processing filter such as a low-pass or high-pass filter, a regressor component, a linear predictor component, an auto-regressive model component, a classifier, a component for dimensionality reduction.

The pipeline generator comprises a user feedback mechanism 102 configured to receive ground truth data from a human operator. The ground truth data comprises labels (or other values) assigned by the human operator to one or more data items from the data store 106 or to a plurality of consecutive data items in a time interval of the time stamped data in the data store 106. The labels (or other values) indicate whether the labeled data is of a particular class (such as anomalous or normal) for example. In the case of a Bayesian approach, the ground truth data comprises probability values for states of a random variable representing the data. In order to facilitate input of the ground truth labels, or other values, by the human operator, the user feedback mechanism may generate a graphical display of at least some of the data from data store 106 overlaid with output computed from the data of data store 106 by a pipeline generated by the pipeline generator. The pipeline generator may receive the ground truth data in the form of annotations to the data from the data store shown graphically on the display. For example, by clicking and dragging to select ranges of values or clicking to select individual points.

The pipeline generator 100 is fully automated. It generates many possible pipelines using template and component library 104 as well as rules, thresholds or constraints on parameter values of the components. The pipeline generator evaluates the possible pipelines using data from data store 106 and optionally uses ground truth data from user feedback mechanism 102. For example, initial evaluation can be computed when user feedback is awaited, and the evaluation re-computed when user feedback becomes available. In some examples the pipeline generator ranks the possible pipelines. The pipeline generator selects at least one of the possible pipelines using the evaluation results.

The pipeline generator sends commands to the data analytics nodes 120 to instantiate the selected pipeline at one or more of the data analytics nodes. Once instantiated, the selected pipeline becomes operational at one or more of the data analytics nodes and control of the email servers 114 or other apparatus is improved. This may be done during live operation of the data analytics nodes so that interruption of control of email servers 114 (or other entities depending on the application domain) is avoided.

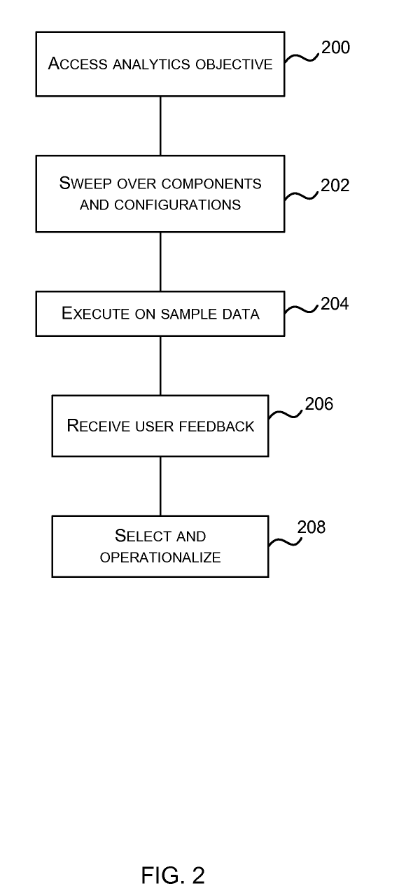

FIG. 2 is a flow diagram of a method at the pipeline generator 100 of FIG. 1. The pipeline generator accesses an analytics objective 200. For example, this may be to detect anomalies in the time series. In another example, it may be to detect patterns in the time series which correlate with one another. The analytics objective may be pre-configured or may be specified by an operator. In some examples the pipeline generator automatically selects the analytics objective from a plurality of options, by assessing characteristics of the sensor data. In this way, a human operator is able to deploy a live data stream analysis system in a simple manner without needing to be an expert on machine learning or data science. For example, a human operator is able to use a single line of code to specify the analytics objective and a source of a live data stream. Using this single line of code the pipeline generator is able to automatically design a suitable pipeline (that is tailored to the application based on the provided feedback/ground truth), deploy the pipeline, and continually update and refine the pipeline on the fly.

The pipeline generator generates a plurality of possible pipelines according to the analytics objective. More detail about how this is done is given later in this document. The pipeline generator sweeps 202 over components and configurations of the possible pipelines. For example, the sweep comprises a search over the possible pipelines made by executing 204 the possible pipelines on a sample of data (from data store 106) and assessing the results.

The pipeline generator receives user feedback 206. In some cases the user feedback comprises selection of a pipeline by the user on the basis of the evaluation results and/or ranking. In some cases user feedback comprising ground truth data is received by the pipeline generator which re-evaluates at least some of the possible pipelines using the ground truth data. The results of the re-evaluation are used by the pipeline generator to automatically select one of the pipelines. The selected pipeline is operationalized 208 by sending commands or instructions to instantiate the selected pipeline at the analytics nodes 120.

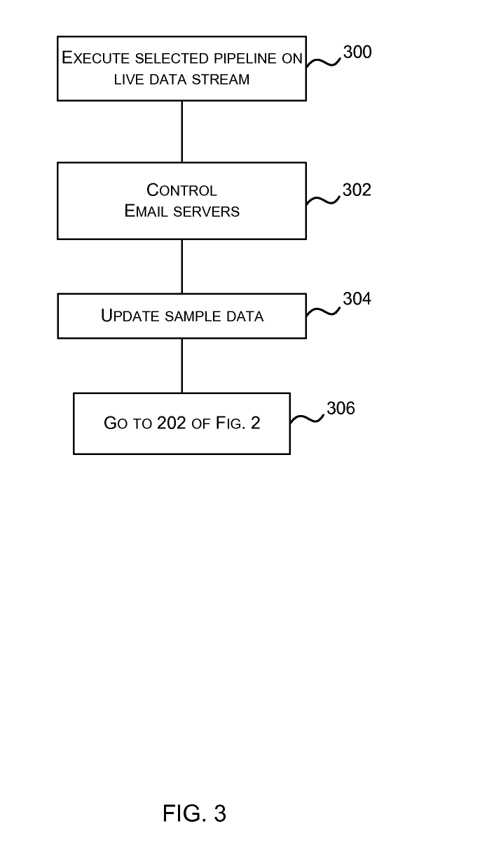

FIG. 3 is a flow diagram of at a data stream actuated control system, such as the arrangement of FIG. 1. This method may occur after the method of FIG. 2 for example. In the method of FIG. 2 the selected pipeline is operationalized. At this point the selected pipeline is executed 300 on a live data stream using the analytics nodes 120. As a result the email servers 114 are controlled 302 using output from alerting 122 and/or control 124 components and control system 112. The sensors 110 sense more data from the email servers 114 and data retention component 108 takes a new sample 304 of the sensor data and stores that in data store 106. The process then returns to box 202 of FIG. 2 to search, evaluate, select and operationalize the pipeline. The point at which the pipeline generator 100 decides to move to box 202 of FIG. 2 may be pre-specified, for example, it may occur at fixed time intervals. In another example, the pipeline generator may return to the pipeline generation process when it receives user input. In another example, the pipeline generator may return to the pipeline generation process according to rules about the observed sensor data 110. For example, where performance data from the email servers 114 falls below a specified threshold, or where error data observed by sensors 110 is too high.

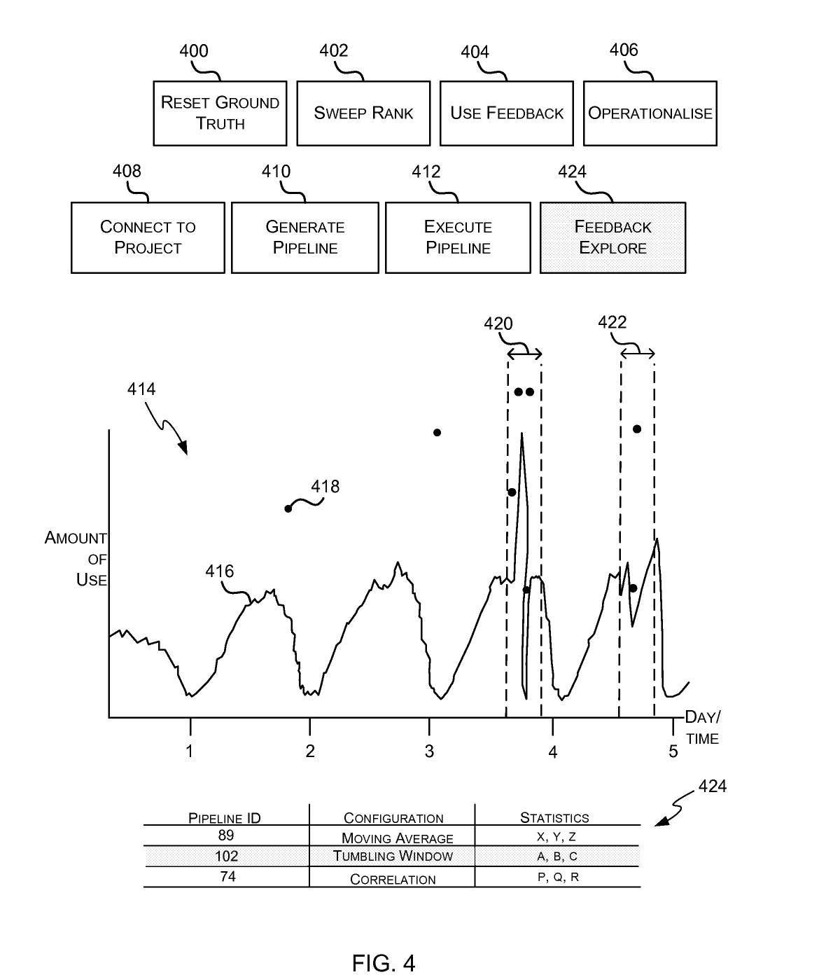

FIG. 4 is a schematic diagram of a graphical user interface of a pipeline generator showing entry of ground truth data by a user. In this example, the graphical user interface has a graphical display 414 showing amount of use of the email servers 114 over several days. Below the graphical display is a table of ranked pipelines. Each row of the table contains a pipeline ID, a short description of configuration of the pipeline, and statistics of the pipeline. In this example only three ranked pipelines are shown. In practice there may be thousands of pipelines, each of which is a potential pipeline design computed by the pipeline generator, and evaluated using the data in data store 106. In this example, one of the pipelines, with ID 102, is highlighted in the table to indicate that evaluation results for this pipeline are currently displayed in the graphical display. The evaluation results are the data points indicated by black spots such as 418. The data from data store 106 is used to create the plot 416 of the graphical display. Thus the graphical display shows the empirical data, and, overlying the empirical data, the evaluation results. In this example, the task of the pipeline is to detect anomalies and evaluation results such as 418 indicate points which are calculated as being potential anomalies. However, it is also possible to use other evaluation results such as detecting patterns of different classes or types.

The user is able to input ground truth labels using the graphical user interface in a fast and effective manner which is easy to understand and use. For example, the end user visually inspects the graphical display and notices that anomalies are likely to be present at time intervals 402 and 422 because the empirical data is erratic and because there is a cluster of evaluation results at those intervals. The user selects the time intervals 402 and 422 and labels these as ground truth anomalies. For example by using the mouse to select the intervals, by operating a slider control, by typing in numerical values of the intervals, or in other ways.

The graphical user interface may comprise one or more ribbons or menu bars enabling the user to control the pipeline generator. These include buttons to reset the ground truth data 400 (for example, where the user changes intervals 420, 422), to sweep and rank 402 (for example, where the user requests the pipeline generator carry out a search of potential pipeline configurations and rank the results of evaluation), to use feedback 404 (for example, where the user requests the pipeline generator to re-do the evaluation using the ground truth data), to operationalize 406 (for example, where the user requests the pipeline generator to operationalize the selected pipeline configuration), to connect to project 408 (for example, where the user requests the pipeline generator to connect to the data stream from the sensors, to generate pipeline 410 (for example, where the user requests the pipeline generator to compute possible pipeline configurations from a template), to execute pipeline 412 (for example, where the user requests the pipeline generator to execute the pipeline configurations on the data from the data store), and feedback explore 424 (for example, where the user requests the pipeline generator to display the graphical display 414 such that ground truth data may be input).

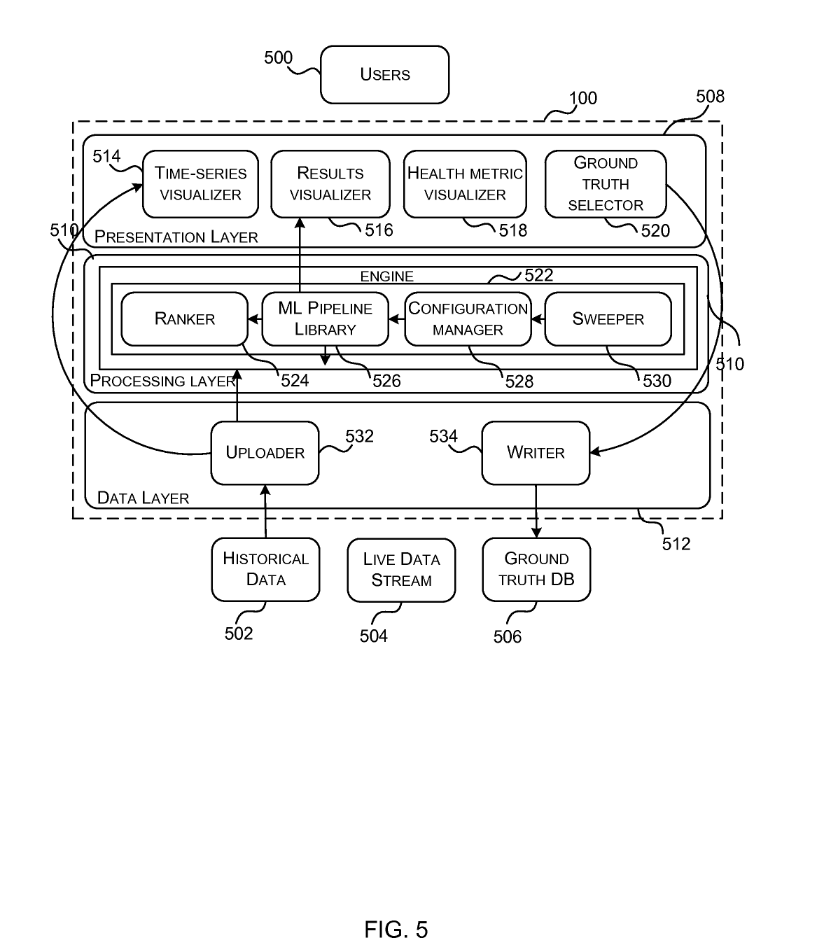

FIG. 5 is a schematic diagram of a pipeline generator 100 in more detail, and during a pipeline generation phase. The pipeline generator has three layers, a presentation layer 508, a processing layer 510 and a data layer 512.

Users 500 interact with the pipeline generator via the presentation layer 508 which comprises various visualization components including a time series visualizer 514, a results visualizer 516, a health metric visualizer 518 and a ground truth selector 520. The time series visualizer takes input from an uploader 532 of the data layer 512 comprising historical data 502 (such as from data store 106 of FIG. 1). The time series visualizer computes a graphical representation of the time series data and outputs that to a graphical user interface such as that of FIG. 4. In the example of FIG. 4 the time series is shown as plot 416. The results visualizer 516 receives evaluation results from the processing layer 522 for specified pipeline configurations. It computes a graphical representation of the evaluation results and outputs that to a graphical user interface such as that of FIG. 4. In the example of FIG. 4 the evaluation results are shown as data points such as 418. The health metric visualizer 518 generates a visual display of the top k best scores output from the evaluation process. The ground truth selector 520 receives input from one or more users specifying labels for values, or ranges of values, of the time series data. It sends the pairs of labels and time series values it receives to a writer 534 of the data layer 512. The writer writes the ground truth data to a ground truth database 506 which may be part of the data store 106 of FIG. 1 or may be at another location accessible to the pipeline generator 100.

As already mentioned, the data layer comprises an uploader 532 and a writer 534. The uploader takes input from a historical data store 502 such as data store 106 of FIG. 1.

The processing layer comprises a ranker 524, a machine learning pipeline library 526, a configuration manager 528 and a sweeper 530. The sweeper 530 is software for carrying out a search of potential pipeline configurations. It may implement any suitable search algorithm, such as depth first search, breadth first search, branch and bound, simulated annealing, random, grid-based or others.

The configuration manager 528 accesses the template and component library (104 of FIG. 1) and selects a template to be used. With the selected template the configuration manager generates potential pipeline configurations, taking into account any pre-specified constraints given in the template, or from another store. For example, constraints on ranges of values which may be input to specified components, constraints on the order in which components may be connected together, constraints on types of values which may be input or output from specified components. As mentioned above, a component may be parameterized. The configuration manager also controls what parameter ranges of the component parameters are to be used in the potential pipeline configurations. The configuration manager feeds the configurations it generates to the ranker.

The machine learning pipeline library 526 is part of the template and component library 104 of FIG. 1. It holds software for implementing various different components.

The ranker is able to control evaluation of the potential pipeline configurations through execution of the relevant machine learning components from library 526. It is arranged to order the potential pipeline configurations on the basis of the evaluation results. For example, the ranker is arranged to find the top k potential pipeline configurations, where k is a number that may be specified by the user or may be pre-configured. The ranker 524 is optional.

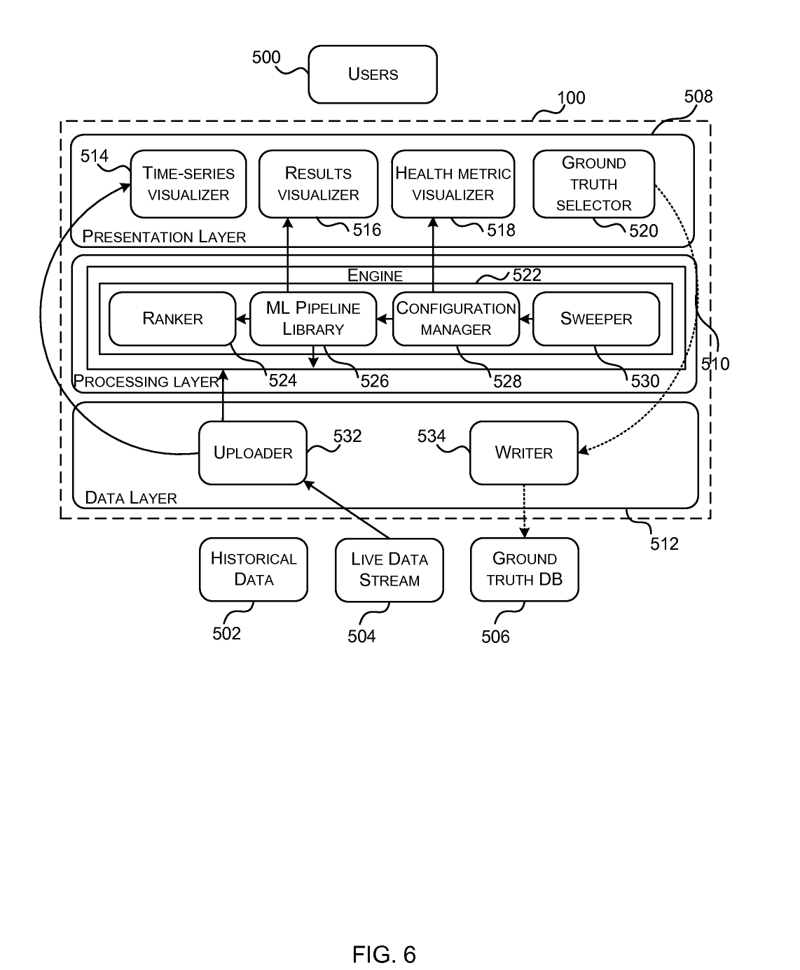

FIG. 6 is the same as FIG. 5 but showing the situation after operationalization. Thus the live data stream 504 is now connected to the uploader 532 rather than the historical data 502. Also, the sweeper is not used and is disconnected from the configuration manager. The processing layer provides output to the health metric visualizer 518 in this case. The health metric visualizer outputs a score of the top k pipelines (as the number of pipelines evaluated is generally large, such as more than 100,000 it is difficult to visualize the scores of all the pipelines and so the top k scoring pipelines are selected. The output from the ground truth selector 520 to the writer 534 and from the writer to ground truth database 506 is shown with a dotted line to indicate that this process may occur after operationalization but does not trigger a new search for a pipeline configuration until a specified time interval has elapsed, or other criteria have been met.

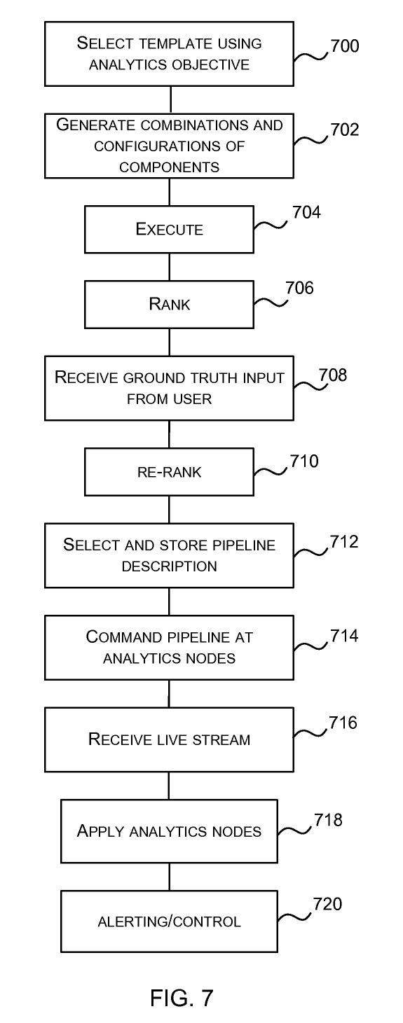

FIG. 7 is a flow diagram of a method at the pipeline generator 100 of FIG. 1 in more detail. A template is selected 700 using an analytics objective. In an example, an analytics objective is anomaly detection. In an example a template for anomaly detection is a template specifying various different components which may be interconnected in different ways to achieve univariate outlier detection. The various different components in this scenario can be a component for calculating a moving average, a component for calculating a finite impulse response (FIR) filter, and a component for calculating a Z Test. Each component is parameterized and constraints on the range of values the parameters may take are given in software for implementing each component.

The pipeline generator generates combinations of configurations of components 702. This comprises picking parameter values of the components and connecting the components together. For example, a heuristic is used to pick the parameter values of the configurations, such as a grid based heuristic or a random selection process. An example of a grid based heuristic is to choose equally spaced values from a parameter range, e.g. from [0,10] choose {0, 2, 4, 6, 8, 10}. The components may be connected together using one or more orders specified in the template, or rules specifying how to order the components.

Once the potential pipeline configurations are created, these are executed 704 using the data in data store 106 to obtain evaluation results. Optionally the pipeline configurations are ranked 706 on the basis of the evaluation results. Ground truth input is optionally received 708 from a user and the pipeline configurations are optionally re-ranked 710 by executing the pipeline configurations on the ground truth data. A ranking may be computed using evaluation measures that either take ground truth into account or not. To compute the evaluation measures and the ranking the pipelines do not need to be executed again. The ranking may use the evaluation results and optionally the ground truth data.

At least one of the pipeline configurations is selected 712. For example, by taking a highest ranked pipeline configuration. Or by manual selection by the user.

A description of the selected pipeline configuration may be stored. The description comprises enough detail to enable operationalization of the selected pipeline. For example, the description has references to software in the template and component library 104 for implementing components in the specified order.

To operationalize the selected pipeline, commands are sent 714 from the pipeline generator 100 to the data analytics nodes 120. For example, the commands instruct the data analytics nodes to instantiate the software referenced in the description of the pipeline configuration at the data analytics nodes. The pipeline generator may optionally send commands to the data retention component 108 to control what and how often data is sampled from the live data stream. The pipeline generator may optionally send commands to the alerting 122 and control 124 components to instruct those components how to use the output of the pipeline, according to the pipeline configuration description.

The live data stream is received 716 at the operationalized pipeline and is processed by the analytics nodes 718 which have the instantiated software. The outputs of the pipeline are received 720 at the alerting and/or control components and are used to control the email servers 114 or other entities.

In the mailbox provisioning example mentioned earlier in this document, the sensor data comprises: error signals from different components such as networking authentication, sending mail, adding contacts; active probing results from servers that mimic a user and report success or failure of performed user actions; event counts such as per time interval and per machine or per rack or per data center of the number of mails sent, the number of new mailboxes created, the number of new email customers. In the mailbox provisioning example the components may comprise de-seasonalization components, filters, moving average computation components, sequential likelihood ratio components, statistical test components, components for computing temporal correlation of results. In the mailbox provisioning example the control system is configured to restart email servers, to alert developer teams, and to send notifications to users.

In an example the email servers are instead nodes of a telecommunications network. The sensors 110 sense network performance data such as traffic levels, dropped calls, frequency of video call stalls, and other network performance data. The operationalized pipeline is arranged to detect patterns in the network performance data, such as seasonal or daily patterns in traffic levels. The control system 112 is arranged to use the detected patterns to reconfigure the telecommunications network, for example, by reconfiguring the telecommunications network parameters such as antenna tilt, base station power parameters, capacity of communications links, and other network parameters.

In another example the email servers are instead nodes in a wireless local area network. The sensors 110 detect network performance parameters such as round trip time, number of dropped packets, traffic levels and other network performance parameters. The operationalized pipeline detects anomalies in the live stream of sensor data to detect errors and/or potential security problems such as packet interception, spoofing and others. The alerting and control components use output from the pipeline to enable control system 112 to trigger alerts, shut down, or by-pass specified wireless nodes when security problems or errors are detected.

In another example the email servers are instead nodes of a cloud computing service. The sensors detect performance parameters such as number of requests received, time delay between receipt of request and serving the request, and other performance parameters. The operationalized pipeline detects anomalies and/or patterns in the stream of sensor data to enable the control system to balance workload, deploy more nodes, or configure parameters of the nodes such that the cloud computing service is provided in a more efficient, robust and cost effective manner.

In examples the sensors comprise sensors on machinery (temperature, pressure, motion, humidity, on/off, etc.), sensors on wireless devices (phones, internet of things (IoT) devices), any kind of telemetry signals.

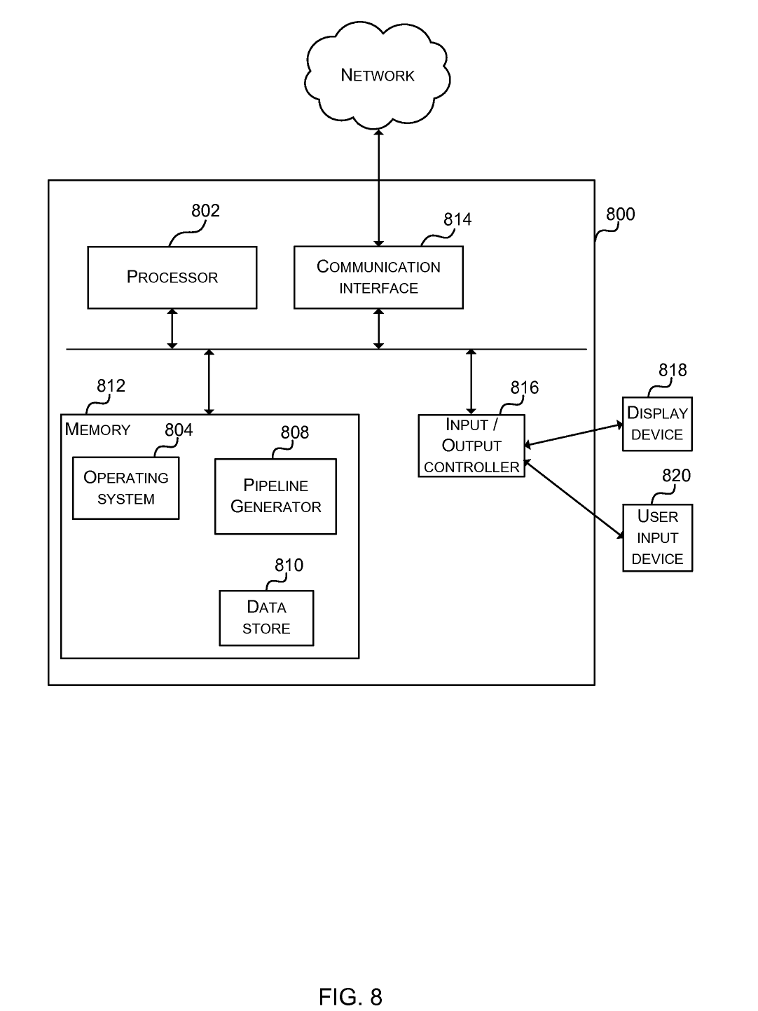

FIG. 8 illustrates various components of an exemplary computing-based device 800 which may be implemented as any form of a computing and/or electronic device, and in which embodiments of a pipeline generator may be implemented.

Computing-based device 800 comprises one or more processors 802 which may be microprocessors, controllers or any other suitable type of processors for processing computer executable instructions to control the operation of the device in order to generate a pipeline for live data stream actuated control of an observed system such as a wireless local area network, a telecommunications network, a plurality of email servers, or others. In some examples, for example where a system on a chip architecture is used, the processors 802 may include one or more fixed function blocks (also referred to as accelerators) which implement a part of the method of any of FIGS. 2, 3 and 7 in hardware (rather than software or firmware). Platform software comprising an operating system 804 or any other suitable platform software may be provided at the computing-based device to enable application software to be executed on the device. Software implementing a pipeline generator 808 may also be provided at the computing-based device.

The computer executable instructions may be provided using any computer-readable media that is accessible by computing based device 800. Computer-readable media may include, for example, computer storage media such as memory 812 and communications media. Computer storage media, such as memory 812, includes volatile and non-volatile, removable and non-removable media implemented in any method or technology for storage of information such as computer readable instructions, data structures, program modules or other data. Computer storage media includes, but is not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer readable instructions, data structures, program modules, or other data in a modulated data signal, such as a carrier wave, or other transport mechanism. As defined herein, computer storage media does not include communication media. Therefore, a computer storage medium should not be interpreted to be a propagating signal per se. Propagated signals may be present in a computer storage media, but propagated signals per se are not examples of computer storage media. Although the computer storage media (memory 812) is shown within the computing-based device 800 it will be appreciated that the storage may be distributed or located remotely and accessed via a network or other communication link (e.g. using communication interface 814).

The computing-based device 800 also comprises an input/output controller 816 arranged to output display information to a display device 818 which may be separate from or integral to the computing-based device 800. The display information may provide a graphical user interface. The input/output controller 816 is also arranged to receive and process input from one or more devices, such as a user input device 820 (e.g. a mouse, keyboard, camera, microphone or other sensor). In some examples the user input device 820 may detect voice input, user gestures or other user actions and may provide a natural user interface (NUI). This user input may be used to input ground truth data, to control the pipeline generator, to view results of the pipeline generator and for other purposes. In an embodiment the display device 818 may also act as the user input device 820 if it is a touch sensitive display device. The input/output controller 816 may also output data to devices other than the display device, e.g. a locally connected printing device.

Any of the input/output controller 816, display device 818 and the user input device 820 may comprise NUI technology which enables a user to interact with the computing-based device in a natural manner, free from artificial constraints imposed by input devices such as mice, keyboards, remote controls and the like. Examples of NUI technology that may be provided include but are not limited to those relying on voice and/or speech recognition, touch and/or stylus recognition (touch sensitive displays), gesture recognition both on screen and adjacent to the screen, air gestures, head and eye tracking, voice and speech, vision, touch, gestures, and machine intelligence. Other examples of NUI technology that may be used include intention and goal understanding systems, motion gesture detection systems using depth cameras (such as stereoscopic camera systems, infrared camera systems, rgb camera systems and combinations of these), motion gesture detection using accelerometers/gyroscopes, facial recognition, 3D displays, head, eye and gaze tracking, immersive augmented reality and virtual reality systems and technologies for sensing brain activity using electric field sensing electrodes (EEG and related methods).

In an example there is a control system comprising:

a communications interface receiving a live data steam of time stamped sensor data observed from a system to be controlled;

an uploader configured to access a store of time-stamped sensor data from the live data stream;

a configuration manager configured to generate a plurality of pipeline configurations for analyzing the live data stream, each pipeline configuration comprising a plurality of components for analyzing data, an order of the components, and values of one or more parameters of each component;

a processor configured to evaluate the pipeline configurations by applying the pipeline configurations to data from the store;

a ground truth selector arranged to receive user input comprising ground truth data being labeled data items from the store of time-stamped sensor data;

the processor configured to re-evaluate the pipeline configurations using the ground truth data and to select one of the pipeline configurations on the basis of the re-evaluation, such that the system to be controlled may be controlled using output of the selected one of the pipeline configurations executing on the live data stream.

The control system may comprise a communication interface configured to send instructions to implement the selected pipeline configuration to one or more analytics nodes of a pipeline processing the live data stream.

The control system may comprise one or more analytics nodes of a pipeline processing the live data stream, the analytics nodes configured to receive a description of the selected pipeline configuration.

The control system may be configured to generate and evaluate another plurality of pipeline configurations using new data observed during execution of the selected pipeline configuration.

The control system of the paragraph immediately above may be configured to generate and evaluate the another plurality of pipeline configurations when the new data meets criteria.

The control system may comprise one or more analytics nodes of a pipeline processing the live data stream in order to detect anomalies or patterns in the live data stream using the selected pipeline configuration and control, on the basis of the detected anomalies or patterns, any of: a telecommunications network, a plurality of email servers, a plurality of cloud computing nodes, a wireless local area network.

The control system may comprise one or more analytics nodes of a pipeline processing the live data stream using the selected pipeline configuration in order to detect anomalies or patterns in the live data stream and trigger alerts on the basis of the detected anomalies or patterns.

The control system may be configured to generate the potential pipeline configurations by selecting the values of the parameters of the components using a grid-based heuristic.

An example provides a computer-implemented method comprising automatically:

accessing a store of time-stamped sensor data from a live data stream, the sensor data observed from a system to be controlled;

generating a plurality of pipeline configurations for analyzing the live data stream, each pipeline configuration comprising a plurality of components for analyzing data, an order of the components, and values of one or more parameters of each component;

evaluating the pipeline configurations by applying the pipeline configurations to data from the store;

receiving user input comprising ground truth data being labeled data items from the store of time-stamped sensor data;

re-evaluating the pipeline configurations using the ground truth data; and

selecting one of the pipeline configurations on the basis of the re-evaluation such that the system to be controlled may be controlled using output of the selected one of the pipeline configurations executing on the live data stream.

The method may comprise sending instructions to implement the selected pipeline configuration to one or more analytics nodes of a pipeline processing the live data stream.

The method may comprise implementing the selected pipeline configuration at one or more analytics nodes of a pipeline processing the live data stream, by sending a description of the selected pipeline configuration to the one or more analytics nodes.

The method may comprise executing the selected pipeline configuration at one or more analytics nodes of a pipeline processing the live data stream and during the executing of the selected pipeline configuration, storing new data in the store and generating and evaluating another plurality of pipeline configurations using the new data.

The method of the paragraph immediately above may comprise generating and evaluating the another plurality of pipeline configurations when the new data in the store meets criteria.

The method may comprise executing the selected pipeline configuration at one or more analytics nodes of a pipeline processing the live data stream in order to detect anomalies or patterns in the live data stream and control, on the basis of the detected anomalies or patterns, any of: a telecommunications network, a plurality of email servers, a plurality of cloud computing nodes, a wireless local area network.

The method may comprise executing the selected pipeline configuration at one or more analytics nodes of a pipeline processing the live data stream in order to detect anomalies or patterns in the live data stream and trigger alerts on the basis of the detected anomalies or patterns.

The method may comprise receiving the ground truth data at a graphical user interface by sending data from the data store to the graphical user interface and receiving the ground truth data in the form of annotations to the data from the data store.

The method may comprise ranking the pipeline configurations using results of the evaluation.

The method may comprise generating the potential pipeline configurations by selecting the values of the parameters of the components at random.

The method may comprise generating the potential pipeline configurations by selecting the values of the parameters of the components using a grid-based heuristic.

An example provides a computer-readable media with device-executable instructions that, when executed by a computing-based device, direct the computing-based device to perform steps comprising:

accessing a store of time-stamped sensor data from a live data stream the sensor data observed from a system to be controlled;

generating a plurality of pipeline configurations for analyzing the live data stream, each pipeline configuration comprising a plurality of components for analyzing data, an order of the components, and values of one or more parameters of each component;

evaluating the pipeline configurations by applying the pipeline configurations to data from the store;

receiving user input comprising ground truth data being labeled data items from the store of time-stamped sensor data;

re-evaluating the pipeline configurations using the ground truth data; selecting one of the pipeline configurations on the basis of the re-evaluation; and

sending instructions to implement the selected pipeline configuration to one or more analytics nodes of a pipeline processing the live data stream such that the system to be controlled may be controlled using output of the selected one of the pipeline configurations executing on the live data stream.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

The term ‘computer’ or ‘computing-based device’ is used herein to refer to any device with processing capability such that it can execute instructions. Those skilled in the art will realize that such processing capabilities are incorporated into many different devices and therefore the terms ‘computer’ and ‘computing-based device’ each include PCs, servers, mobile telephones (including smart phones), tablet computers, set-top boxes, media players, games consoles, personal digital assistants and many other devices.

The methods described herein may be performed by software in machine readable form on a tangible storage medium e.g. in the form of a computer program comprising computer program code means adapted to perform all the steps of any of the methods described herein when the program is run on a computer and where the computer program may be embodied on a computer readable medium. Examples of tangible storage media include computer storage devices comprising computer-readable media such as disks, thumb drives, memory etc and do not include propagated signals. Propagated signals may be present in a tangible storage media, but propagated signals per se are not examples of tangible storage media. The software can be suitable for execution on a parallel processor or a serial processor such that the method steps may be carried out in any suitable order, or simultaneously.

This acknowledges that software can be a valuable, separately tradable commodity. It is intended to encompass software, which runs on or controls “dumb” or standard hardware, to carry out the desired functions. It is also intended to encompass software which “describes” or defines the configuration of hardware, such as HDL (hardware description language) software, as is used for designing silicon chips, or for configuring universal programmable chips, to carry out desired functions.

Those skilled in the art will realize that storage devices utilized to store program instructions can be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a DSP, programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The steps of the methods described herein may be carried out in any suitable order, or simultaneously where appropriate. Additionally, individual blocks may be deleted from any of the methods without departing from the spirit and scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the spirit or scope of this specification.

1. A control system comprising:
a communications interface receiving a live data steam of time stamped sensor data observed from a system to be controlled;
an uploader configured to access a store of time-stamped sensor data from the live data stream;
a configuration manager configured to generate a plurality of pipeline configurations for analyzing the live data stream, each pipeline configuration comprising a plurality of components for analyzing data, an order of the components, and values of one or more parameters of each component;
a processor configured to evaluate the pipeline configurations by applying the pipeline configurations to data from the store; and
a ground truth selector arranged to receive user input comprising ground truth data being labeled data items from the store of time-stamped sensor data;
the processor configured to re-evaluate the pipeline configurations using the ground truth data and to select one of the pipeline configurations on the basis of the re-evaluation, such that the system to be controlled may be controlled using output of the selected one of the pipeline configurations executing on the live data stream.

2. The system of claim 1 further comprising a communication interface configured to send instructions to implement the selected pipeline configuration to one or more analytics nodes of a pipeline processing the live data stream.

3. The system of claim 1 comprising one or more analytics nodes of a pipeline processing the live data stream, the analytics nodes configured to receive a description of the selected pipeline configuration.

4. The system of claim 1 configured to generate and evaluate another plurality of pipeline configurations using new data observed during execution of the selected pipeline configuration.

5. The system of claim 4 configured to generate and evaluate the another plurality of pipeline configurations when the new data meets criteria.

6. The system of claim 1 comprising one or more analytics nodes of a pipeline processing the live data stream in order to detect anomalies or patterns in the live data stream using the selected pipeline configuration and control, on the basis of the detected anomalies or patterns, any of: a telecommunications network, a plurality of email servers, a plurality of cloud computing nodes, a wireless local area network.

7. The system of claim 1 comprising one or more analytics nodes of a pipeline processing the live data stream using the selected pipeline configuration in order to detect anomalies or patterns in the live data stream and trigger alerts on the basis of the detected anomalies or patterns.

8. The system of claim 1 configured to generate the potential pipeline configurations by selecting the values of the parameters of the components using a grid-based heuristic.

9. A computer-implemented method comprising automatically:
accessing a store of time-stamped sensor data from a live data stream, the sensor data observed from a system to be controlled;
generating a plurality of pipeline configurations for analyzing the live data stream, each pipeline configuration comprising a plurality of components for analyzing data, an order of the components, and values of one or more parameters of each component;
evaluating the pipeline configurations by applying the pipeline configurations to data from the store;
receiving user input comprising ground truth data being labeled data items from the store of time-stamped sensor data;
re-evaluating the pipeline configurations using the ground truth data; and
selecting one of the pipeline configurations on the basis of the re-evaluation such that the system to be controlled may be controlled using output of the selected one of the pipeline configurations executing on the live data stream.

10. The method of claim 9 further comprising sending instructions to implement the selected pipeline configuration to one or more analytics nodes of a pipeline processing the live data stream.

11. The method of claim 9 further comprising implementing the selected pipeline configuration at one or more analytics nodes of a pipeline processing the live data stream, by sending a description of the selected pipeline configuration to the one or more analytics nodes.

12. The method of claim 9 comprising executing the selected pipeline configuration at one or more analytics nodes of a pipeline processing the live data stream and during the executing of the selected pipeline configuration, storing new data in the store and generating and evaluating another plurality of pipeline configurations using the new data.

13. The method of claim 12 comprising generating and evaluating the another plurality of pipeline configurations when the new data in the store meets criteria.

14. The method of claim 9 comprising executing the selected pipeline configuration at one or more analytics nodes of a pipeline processing the live data stream in order to detect anomalies or patterns in the live data stream and control, on the basis of the detected anomalies or patterns, any of: a telecommunications network, a plurality of email servers, a plurality of cloud computing nodes, a wireless local area network.

15. The method of claim 9 comprising executing the selected pipeline configuration at one or more analytics nodes of a pipeline processing the live data stream in order to detect anomalies or patterns in the live data stream and trigger alerts on the basis of the detected anomalies or patterns.

16. The method of claim 9 comprising receiving the ground truth data at a graphical user interface by sending data from the data store to the graphical user interface and receiving the ground truth data in the form of annotations to the data from the data store.

17. The method of claim 9 comprising ranking the pipeline configurations using results of the evaluation.

18. The method of claim 9 wherein generating the potential pipeline configurations comprises selecting the values of the parameters of the components at random.

19. The method of claim 9 wherein generating the potential pipeline configurations comprises selecting the values of the parameters of the components using a grid-based heuristic.

20. A computer-readable media with device-executable instructions that, when executed by a computing-based device, direct the computing-based device to perform steps comprising:
accessing a store of time-stamped sensor data from a live data stream the sensor data observed from a system to be controlled;
generating a plurality of pipeline configurations for analyzing the live data stream, each pipeline configuration comprising a plurality of components for analyzing data, an order of the components, and values of one or more parameters of each component;
evaluating the pipeline configurations by applying the pipeline configurations to data from the store;
receiving user input comprising ground truth data being labeled data items from the store of time-stamped sensor data;
re-evaluating the pipeline configurations using the ground truth data; selecting one of the pipeline configurations on the basis of the re-evaluation; and
sending instructions to implement the selected pipeline configuration to one or more analytics nodes of a pipeline processing the live data stream such that the system to be controlled may be controlled using output of the selected one of the pipeline configurations executing on the live data stream.
